(19) United States
(12) Patent Application Publication
(10) Pub. No.: US 2013/0252212 A1
(43) Pub. Date: Sep. 26, 2013

(54) Language learning assistant

(71) Applicant: Ravi Purushotma, Santa Clara, CA (US)

(72) Inventor: Ravi Purushotma, Santa Clara, CA (US)

(21) Appl. No.: 13/759,039

(22) Filed: May 7, 2013

Related U.S. Application Data
(63) Continuation-in-part of application No. 12/501,947, filed on Jul. 13, 2009, now abandoned.

(51) Int. Cl. G09B 19/06

(52) U.S. Cl. CPC G09B 19/06
USPC 434/157

(57) ABSTRACT

A system and method for learning a language includes displaying set of first terms that enables the user to begin a sentence. A selection of a first term of the set of first terms causes a first set of child terms to be retrieved based on the selection of the first term and is displayed to the user. The first set of child terms may combine with the first term based on grammatical rules or semantic conventions. A second set of child terms may be displayed based on the first set of child terms and/or completion of the sentence. The meaning of the sentence may determine at least one of (a) a subsequent display of first terms, (b) modification of a previously presented display of terms, (c) subsequent display of a question or dialog that is responsive to the formed sentence, and (d) subsequent display of a narrative element.

### CROSS-REFERENCE TO RELATED APPLICATIONS

The present disclosure clams priority under 35 U.S.C. §120 and is a continuation-in-part of pending U.S. Non-Provisional Patent application Ser. No. 12/501,947, filed on Jul. 13, 2009, which claims priority under 35 U.S.C. §119 on U.S. Provisional Patent Application Ser. No. 611079,831, filed on Jul. 11, 2008, the disclosures of which applications are incorporated by reference.

### FIELD OF THE DISCLOSURE

The present disclosure generally relates to a language learning assistant, and, more particularly, to a method, and system for assisting users in learning languages.

### BACKGROUND OF THE DISCLOSURE

Over centuries, spoken and written languages have evolved as two of the most important forms of communication among people. As of today, a plurality of languages exists in various geographic regions and in different social and ethnic groups all over the world. People belonging to a specific geographic region or social or ethnic groups may communicate with one another using a specific language, which may be different from languages used by people belonging to different geographic regions or social or ethnic groups. Accordingly, it may be difficult for two people from different regions or groups to communicate if there is no common language of communication between them, thereby requiring people to learn foreign languages.

Typically, a language may be learned with help from a tutor or from other language learning resources, such as language books. However, with advancement in technology, various computer-based language learning systems have been developed that enable a person to learn a language in a self-paced, but interactive fashion. Such language learning systems receive input from a user in a language known to the user and provide a translated sentence in another language. Some language learning systems provide translation of a selected set of sentences only. More specifically, such language learning systems provide a user with a set of pre-built sentences in one language and a translation thereof in another language. Upon selecting a sentence from the set of pre-built sentences, the language learning system may readily provide a translation of the sentence to the user. Some other language learning systems provide a user with a set of pre-built sentences in a target language. The user may select a sentence from the set of pre-built sentences. Further, the language learning systems may help the user in understanding meaning of the selected sentence by providing a translation, an animation, and the like.

However, the existing language learning systems do not recognize more nuanced difficulties in a user's language comprehension abilities. More specifically, the existing language learning systems bypass a cognitive thinking process of the user by providing him/her with a pre-translated sentence to choose from. Accordingly, the user is unable to obtain a complete knowledge of grammar and vocabulary of the language that he/she intends to learn.

Accordingly, there persists a need for recognizing difficulties in a user's language comprehension abilities. Further, there persists a need for enabling a user to apply a cognitive thinking process while learning a language. Furthermore, there exists a need to enable a user to learn grammar and vocabulary of a language in a fast, easy and reliable manner.

### SUMMARY OF THE DISCLOSURE

In view of the foregoing disadvantages inherent in the prior art, the general purpose of the present disclosure is to provide a method, system and computer program product for assisting a user in learning a target language, that is configured to include all advantages of the prior art, and to overcome the drawbacks inherent therein.

Therefore, an object of the present disclosure is to recognize difficulties in a user's language comprehension abilities.

Another object of the present disclosure is to enable a user to apply a cognitive thinking process while learning a language.

Yet another object of the present disclosure is to enable a user to learn grammar and vocabulary of a language in a fast, easy and reliable manner.

Accordingly, in an aspect of the present disclosure, a method is provided for assisting a user in learning a target language. The target language includes a plurality of terms. The plurality of terms includes a plurality of words and a plurality of phrases. A set of first terms of the plurality of terms is displayed. Each first term of the set of first terms enables the user to begin a sentence in the target language. Further, a selection of a first term of the set of first terms is received from the user. A first set of child terms of the plurality of terms is retrieved from a repository based on the selection of the first term. Thereafter, the first set of child terms is displayed. Each child term of the first set of child terms is capable of being combined with the first term based on, for example, grammatical rules or semantic conventions (including, but not necessarily limited to, multiple semantic conventions, i.e., alternate meanings of a term) of the target language. The first term is a parent term of the first set of child terms. A term of the plurality of terms is associated with at least one meaning. The at least one meaning is represented visually. A first child term of the first set of child terms is a parent term for a second set of child terms. The second set of child terms is displayed subsequent to the first set of child terms based on at least one of receiving a selection of the first child term and completion of the sentence in the target language. Selections of the first term, the first child term and subsequent child terms are received from the user to form the sentence in the target language, thereby assisting the user in learning the target language. Furthermore, based on the meaning of the sentence so completed or formed, the method may thereafter display a subsequent set of first terms, modify a previously-presented set of terms, display a question or dialog that is responsive to the formed sentence, and/or display a narrative element that corresponds to the formed sentence.

The method for assisting the user in learning the target language also includes displaying an animation that is associated with formation of the sentence. The animation represents connection of selected terms to form the sentence. The animation enables the user to apply a cognitive thinking process to construction of the sentence.

Further, the method for assisting the user in learning the target language includes displaying at least one meaning of a term of the plurality of terms to the user. The at least meaning is represented as one of a translation of the term and a picture of the term. Further, the at least one meaning is displayed upon receiving an indication from the user. Accordingly, the method recognizes difficulties in a user's language comprehension abilities.

In another aspect of the present disclosure, a system is provided for assisting a user in learning a target language. The target language includes a plurality of terms. The plurality of terms includes a plurality of words and a plurality of phrases. The system includes a display module, an input module and a language module. The display module is capable of displaying a set of first terms of the plurality of terms. Each first term of the set of first terms enables the user to begin a sentence in the target language. The input module is capable of receiving a selection of a first term of the set of first terms from the user. The language module is capable of retrieving a first set of child terms of the plurality of terms from a repository based on the selection of the first term. The display module is further capable of displaying the first set of child terms. Each child term of the first set of child terms is capable of being combined with the first term based on, for example, grammatical rules or semantic conventions of the target language. The first term is a parent term of the first set of child terms. A term of the plurality of terms is associated with a meaning. The meaning is represented visually. A first child term of the first set of child terms is a parent term for a second set of child terms. The second set of child terms is displayed by the display module subsequent to the first set of child terms based on at least one of receiving a selection of the first child term by the input module and completion of the sentence in the target language. Selections of the first term, the first child term and subsequent child terms are received from the user by using the input module to form the sentence in the target language, thereby assisting the user in learning the target language. Furthermore, based on the meaning of the sentence so completed or formed, the method may thereafter display a subsequent set of first terms, modify a previously-presented set of terms, display a question or dialog that is responsive to the formed sentence, and/or display a narrative element that corresponds to the formed sentence.

In yet another aspect of the present disclosure, a computer program product is embodied on a computer readable medium for assisting a user in learning a target language. The target language includes a plurality of terms. The plurality of terms includes a plurality of words and a plurality of phrases. The computer program product includes a program module having a set of instructions for displaying a set of first terms of the plurality of terms. Each first term of the set of first terms enables the user to begin a sentence in the target language. Further, the computer program product includes a set of instructions for receiving a selection of a first term of the set of first terms from the user. Still further, the computer program product includes a set of instructions for retrieving a first set of child terms of the plurality of terms from a repository based on the selection of the first term. Yet further, the computer program product includes a set of instructions for displaying the first set of child terms. Each child term of the first set of child terms is capable of being combined with the first term based on, for example, grammatical rules or semantic conventions of the target language. The first term is a parent term of the first set of child terms. A term of the plurality of terms is associated with a meaning. The meaning is represented visually. A first child term of the first set of child terms is a parent term for a second set of child terms. The second set of child terms is displayed subsequent to the first set of child terms based on at least one of receiving a selection of the first child term and completion of the sentence in the target language. Selections of the first term, the first child term and subsequent child terms are received from the user to form the sentence in the target language, thereby assisting the user in learning the target language. Furthermore, based on the meaning of the sentence so completed or formed, the method may thereafter display a subsequent set of first terms, modify a previously-presented set of terms, display a question or dialog that is responsive to the formed sentence, and/or display a narrative element that corresponds to the formed sentence.

These together with other aspects of the present disclosure, along with the various features of novelty that characterize the present disclosure, are pointed out with particularity in the claims annexed hereto and form a part of this present disclosure. For a better understanding of the present disclosure, its operating advantages, and the specific objects attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 depicts a block diagram of a system for assisting a user in learning a target language, in accordance with an embodiment of the present disclosure.

FIG. 2 is a flow diagram representing a method for assisting a user in learning a target language, in accordance with an embodiment of the present disclosure;

FIG. 3 is a flow diagram representing a method for assisting a user in learning a target language, in accordance with an embodiment of the present disclosure;

FIG. 4 is a flow diagram representing a method for assisting a user in learning a target language, in accordance with another embodiment of the present disclosure;

FIG. 5 is a flow diagram representing a method for assisting a user in learning a target language, in accordance with yet another embodiment of the present disclosure;

FIGS. 6A and 6B depict exemplary user interfaces for modifying grammatical properties of one or more terms in the target language, in accordance with an exemplary embodiment of the present disclosure;

FIGS. 7A and 7B depict exemplary user interfaces for modifying grammatical properties of a sentence of a target language, in accordance with an embodiment of the present disclosure;

FIG. 8 depicts an exemplary user interface for displaying a meaning of a term of a plurality of terms of the target language to the user, in accordance with an exemplary embodiment of the present disclosure;

FIG. 9 depicts a user interface on a processing device for assisting a user in forming a sentence in a target language, in accordance with an embodiment of the present disclosure; and

FIG. 10 depicts a user interface on a processing device with a false answer feature activated, in accordance with an embodiment of the present disclosure.

Like reference numerals refer to like parts throughout the description of several views of the drawings.

### DETAILED DESCRIPTION OF THE DISCLOSURE

For a thorough understanding of the present disclosure, reference is to be made to the following detailed description, including the appended claims, in connection with the above-described drawings. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present disclosure provides a method and a system for assisting a user in learning a target language. The target language includes a plurality of terms. The plurality of terms includes a plurality of words and a plurality of phrases. The system enables the user to learn grammatical rules and vocabulary of the target language through visual learning aids. The system may be deployed on a processing device, such as a computer, a mobile phone, a Personal Digital Assistant (PDA), a laptop, and the like.

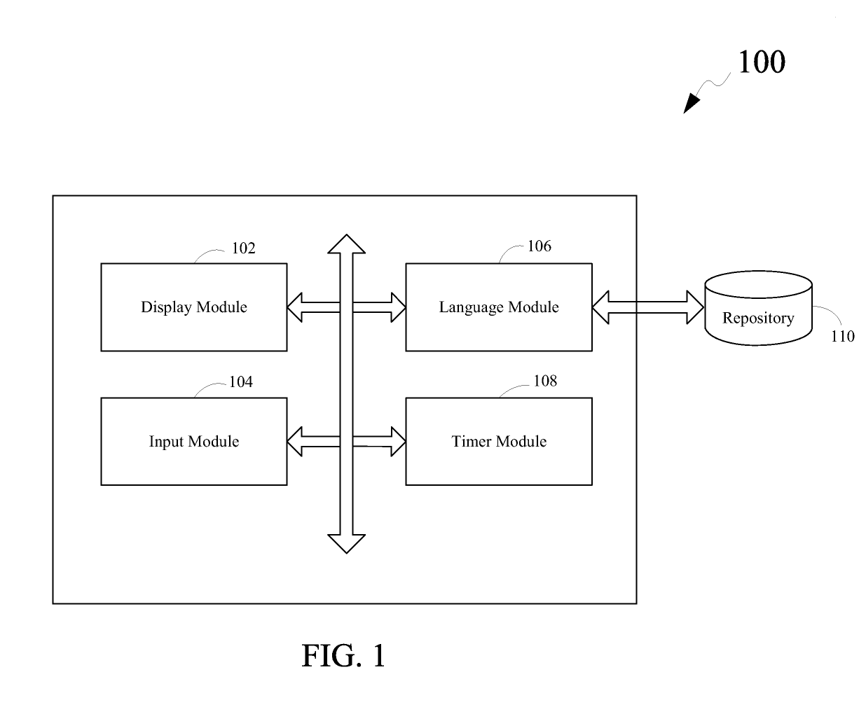

FIG. 1 depicts a block diagram of a system 100 for assisting a user in learning a target language, in accordance with an embodiment of the present disclosure. The target language includes a plurality of terms. The plurality of terms includes a plurality of words, such as ‘girl’, ‘sea’, ‘football’, ‘I’, and the like, and a plurality of phrases, such as ‘bent upon’, ‘responsible for’, and the like. Examples of the target language may include languages, such as English, French, German, Chinese, Japanese, and other languages spoken in different parts of the world. The system 100 includes a display module 102, an input module 104, a language module 106, a timer module 108 and a repository 110.

The display module 102 is capable of displaying a set of first terms of the plurality of terms to the user. Each first term of the set of first terms enable the user to begin a sentence in the target language. The input module 104 is capable of receiving a selection of a first term of the set of first terms from the user. The language module 106 is capable of retrieving a first set of child terms of the plurality of terms from the repository 110 based on the selection of the first term. The display module 102 is further capable of displaying the first set of child terms to the user. Each child term of the first set of child terms is capable of being combined with the first term based on, for example, grammatical rules or semantic conventions of the target language. The first term is a parent term of the first set of child terms. Further, each term of the plurality of terms is associated with a meaning. The meaning is capable of being represented visually through the display module 102. Furthermore, a first child term of the first set of child terms is a parent term for a second set of child terms. The second set of child terms is displayed by the display module 102 subsequent to the first set of child terms based on at least one of receiving a selection of the first child term by the input module 104 and completion of the sentence in the target language. Furthermore, selections of the first term, the first child term and subsequent child terms are received from the user by using the input module 104 to form the sentence in the target language, thereby assisting the user in learning the target language. In another embodiment, a second set of child terms may be displayed simultaneously with a first set of child terms to facilitate a user in viewing possible combinations of a parent term, first sent of child terms, and a second set of child terms. In another embodiment, all second set of terms that are based on grammatical rules or semantic conventions may be displayed with a particular first set of child terms or all first sets of child terms. In yet another embodiment, based on the meaning of the sentence so completed or formed, the method may thereafter display a subsequent set of first terms, modify a previously-presented set of terms, display a question or dialog that is responsive to the formed sentence, and/or display a narrative element that corresponds to the formed sentence.

More specifically, the sentence may be formed by combining terms selected by the user. The terms may be displayed to the user on the display module 102 for receiving the selections of the terms. Examples of the display module 102 may include Cathode Ray Tube (CRT) monitors, Liquid Crystal Display (LCD) monitors, touch screen monitors, and the like. In another embodiment of the disclosure, the display module 102 is capable of displaying a complete sentence in the target language to the user.

In an embodiment of the present disclosure, the display module may be further capable of displaying a set of buttons to the user. Each button of the set of buttons may indicate a corresponding term of the set of terms. The set of terms may be one of the set of first terms and a subsequent set of child terms of the plurality of terms. Examples of the subsequent set of child terms include the first set of child terms, the second set of child terms, a third set of child terms, and the like. The display module may display the set of buttons in various shapes and colors. A shape of a button of the set of buttons may be one of a geometrical shape and a cartoon character shape. The buttons may remain active after selection by a user to allow the user to adjust his selections after a corresponding set of terms is displayed on selection of a button.

In another embodiment of the present disclosure, the display module 102 may be configured to maintain visibility of selected terms. For the purpose of this description, the selected terms refer to those terms of the plurality of terms that are selected by the user for forming the sentence. The user may select five terms to form the sentence. Visibility of the five terms selected by the user may be maintained by the display module 102. More specifically, the display module 102 may be configured to maintain the visibility of buttons that correspond to the selected terms.

In another embodiment of the present disclosure, the display module 102 may be configured to display an animation associated with formation of the sentence. The animation may represent connection of the selected terms to form the sentence. For example, for a sentence ‘The snowman gave the tie to the rabbit’, an animation depicting formation of the sentence may be displayed. The animation may depict meanings or grammatical properties of each of the selected terms.

In yet another embodiment of the present disclosure, the display module 102 may be configured to display the meaning of a term of the plurality of terms to the user. The meaning of the term may at least be one of a translation of the term and a picture of the term. The translation of the term may refer to an alternate term in another language that corresponds to the term in the target language. The alternate term in the alternate language may be known to the user. Similarly, the picture may provide a visual representation of the term to the user, thereby assisting the user in understanding the meaning of the term. The display module 102 may be configured to display at least one of the translation of the term and the picture of the term to the user to depict the meaning of the term.

In still another embodiment of the present disclosure, the display module 102 may be configured to display a set of terms of the plurality of terms to the user. A term of the set of terms may be associated with one of a color and a shape. The color or the shape may be associated with the term to indicate a gender-specific usage of the term. For example, in English, terms such as ‘her’, ‘his’, ‘herself’, and the like, are associated with a gender. In another example, in German all nouns are associated with a gender. In German, the sun, known as ‘Sonne’ is female and the moon known as ‘Mond’ is male. Accordingly, a color, such as pink may be associated with terms that are associated with female gender. Similarly, a color, such as blue, may be associated with terms that are associated with male gender. Alternatively, terms of the female gender may be associated with a first pre-defined shape. Similarly, terms of the male gender may be associated with a second pre-defined shape. The display module 102 may display the term as a button that may be colored with the color or shaped according to the gender of the term, thereby indicating the usage of the term to the user.

In yet another embodiment of the present disclosure, the display module 102 may be configured to display a set of modifiers of the target language to the user. A modifier of the set of modifiers is capable of being combined with one or more terms of the sentence based on the grammatical rules of the target language. For the purpose of description of this disclosure, a modifier may be defined as a term that modifies a part of the sentence or modifies the grammatical properties of the sentence. Examples of modifiers in a language, such as English, include adjectives, adverbs and modifier phrases. Further, one or more letters, such as ‘s’, ‘ed’, ‘anti-,’ ‘counter-,’ ‘dis,’ ‘inter,’ ‘tion,’ ‘iness,’ ‘ism,’ and ‘ly’ are also examples of modifiers that modify the grammatical properties of the sentence. The display module 102 may display the set of modifiers to the user in the form of a set of buttons.

In still another embodiment of the present disclosure, the display module 102 may be configured to display a tense of the sentence to indicate one of a past tense, a present tense and a future tense. The tense of the sentence may be indicated by at least one of a picture and a color. The display module 102 may display a white background color for the sentence to indicate that the sentence is in simple present tense. The display module 102 may display a grey background color for the sentence and a clock with a backwards arrow to indicate that the sentence is in past tense. Further, the display module 102 may display the clock that has a forward arrow to indicate that the sentence is in the future tense.

In yet another embodiment of the present disclosure, the display module 102 may be configured to display the set of terms to the user. The set of terms may include at least one false answer. For the purpose of this description, a false answer may be defined as a common language mistake that may be made by a user learning the target language. For example, for the target language, such as English, a term, such as ‘comb’, may be modified from present tense to past tense by using a modifier ‘ed’ to form ‘combed’. However, such modification may not be applicable for each term of the plurality of terms of the target language. For example, a term, such as ‘go’, has a past tense form ‘went’. A false answer, such as ‘goed’ may be randomly generated or may be stored in the repository 110, to display the at least one false answer to the user. Further, the display module 102 may be configured to provide a feedback to the user when a false answer of the at least one false answer is selected by the user. The feedback indicates to the user that a mistake has occurred. For example, the display module 102 may depict an explosion of the false answer to indicate to the user that a mistake has occurred. In an embodiment of the present disclosure, a part of the false answer that makes the false answer false may highlight before exploding. Further, a pop-up may be displayed by the display module 102. The pop-up may include a learning to indicate correct form of the term selected by the user.

It may be apparent to a person skilled in the art that the display module 102 may be configured to display each of the above described embodiments as menu options to the user. The user may be enabled to select a menu option of the menu options by utilizing the input module 104.

The input module 104 is communicably coupled to the display module 102. The input module 104 is capable of receiving a selection of a term of a set of terms of the plurality of terms displayed to the user by the display module 102. The set of terms may be the first set of terms or any set of terms displayed subsequent to the first set of terms. Examples of the input module 104 include a keyboard, a mouse, a joystick, a touch screen device, a voice command, Infra Red (IR) rays, and the like. The selection may be received by the input module 104 through keystrokes on the keyboard, movement of the joystick, touch on the touch screen device, click of the mouse, pointing of the mouse without a click, the voice command and the IR rays from a remote control.

In an embodiment of the present disclosure, the input module 104 may be capable of receiving a selection of a button of the set of buttons from the user. Specifically, the button selected by the user may correspond to a term of the set of terms displayed by the display module 102. The button may be selected by the user by using the input module 104. The input module 104, such as the mouse, may be capable of receiving the selection of the button through movement of the mouse over the button.

In another embodiment of the present disclosure, the input module 104 may be configured to receive an indication from the user for displaying the meaning of a term of the plurality of terms. The user may require the meaning of a term while forming the sentence in the target language. The user may indicate the term through the input module 104. Specifically, the input module 104 may be configured to receive a pointer pointing to the term. The pointer may be pointed to the term for a pre-defined period of time. The input module 104 may be communicably coupled to the timer module 108. The timer module 108 may be configured to calculate presence of the pointer on the term for the pre-defined period of time. For example, the user may point a pointer of the mouse on the term whose meaning is required by the user for one second. The timer module 108 calculates the presence of the pointer on the term and notifies the input module 104. In an embodiment of the present disclosure, the pre-defined period of time may be a randomly generated number. The timer module 108 may be configured to generate the number. The input module 104 may then receive the indication that refers to the term. Alternatively, the user may click on a term to indicate that the meaning of the term is required.

In yet another embodiment of the present disclosure, the input module 104 may be configured to receive an input from the user for activating a false answer feature associated with language mistakes of the target language. The input may be received through at least one of click on the mouse, movement of the joystick, and the like. Upon receiving the input from the user, the set of terms, such as the set of first terms and the subsequent set of terms, displayed to the user by the display module 102 may include the at least one false answer.

In still another embodiment of the present disclosure, the input module 104 may be configured to receive a selection of a modifier of the set of modifiers from the user based on the set of modifiers displayed by the display module 102. The input module 104 may receive the selection of the modifier through the click on the mouse, the movement of the joystick, the touch on the touch screen, and the like.

In yet another embodiment of the present disclosure, the input module 104 may enable the user to move the selected terms with the sentence to modify the sentence. It will be apparent to a person skilled in the art that the input module 104 may be configured to include combination of the embodiments explained above.

The input module 104 may be communicably coupled to the language module 106. The language module 106 is capable of retrieving a set of child terms of the plurality of terms from the repository 110 based on the selection of the parent term by the user. For the purpose of this description, the parent term may be the first term or a term of the plurality of terms that is selected by the user. A term selected by the user may also be referred to as the parent term of a subsequent set of terms of the plurality of terms that is displayed to the user. Each term of the subsequent set of terms may be a child term of the parent term. A child term is a term that may be combined with the parent term based on the grammatical rules or semantic conventions of the target language. The language module 106 may be configured to access the grammatical rules or semantic conventions of the target language for retrieving the set of child terms from the repository 110.

In an embodiment of the present disclosure, the language module 106 may be configured to extract the meaning associated with the indicated term from the repository 110. As mentioned previously, the indication of a term may be received from the user by the input module 104. The indication may refer to the term whose meaning is to be displayed to the user. The indicated term may be extracted from the repository 110 by the language module 106. The meaning of the indicated term may be represented as at least one of a translation of the indicated term and a picture of the indicated term. Accordingly, the language module 106 may extract at least one of the translation and the picture from the repository 110. Further, the language module 106 may be configured to extract the meaning of the indicated term from an alternative source (not shown), such as a dictionary or a website. The language module 106 may extract the meaning from the alternative source when the repository 110 includes a web link to the meaning of the indicated term. Alternatively, the language module 106 may extract the meaning of the indicated term from the alternative source when the indicated term is not present in the repository 110.

In another embodiment of the present disclosure, the language module 106 may be configured to update the plurality of terms in the repository 110. More specifically, the language module 106 may be configured to retrieve one or more new terms of the target language from the alternative source for updating the plurality of terms in the repository 110. Further, the language module 106 may be configured to extract one or more meanings of the one or more new terms from the alternative source. Furthermore, the language module 106 may be configured to extract usage of the one or more new terms from the alternative source. The system 100 may include a transceiver module (not shown) that may be capable of transmitting and receiving the one or more new terms and corresponding one or more meanings from the alternative sources.

In yet another embodiment of the present disclosure, the language module 106 may be configured to enable the user to modify the grammatical properties of the sentence based on the set of modifiers displayed by the display module. The grammatical properties of the sentence are one of a tense of the sentence, a grammatical number property of the sentence, a subject of the sentence, a direct object of the sentence, an indirect object of the sentence and an active voice or a passive voice of the sentence. More specifically, the set of modifiers displayed to the user by the display module 102 may be related to modifying the tense of the sentence, the grammatical number property of the sentence, the subject of the sentence, the direct object of the sentence, the indirect object of the sentence or modifying the sentence from active voice to passive voice and vice versa. Further, the language module 106 may be configured to combine a modifier of the set of modifiers selected by the user with the one or more terms of the sentence for modifying the grammatical properties of the sentence. For example, a modifier, such as ‘intelligent’ may be provided in the set of modifiers. The modifier may be used prior to a term, such as ‘boy’ in the sentence, to form ‘intelligent boy’. In another example, a modifier, such as ‘s’ may be provided in the set of modifiers. The modifier ‘s’ may be added as a suffix to at least one term of the selected terms that form the sentence, for converting the sentence into plural form. It will be apparent to a person skilled in the art that the set of modifiers may be language specific.

In still another embodiment of the present disclosure, the language module 106 may be configured to generate the at least one false answer. The at least one false answer may be displayed to the user along with the set of terms for forming the sentence, as explained previously.

In still another embodiment of the present disclosure, the language module 106 may be configured to determine correctness of the sentence formed by the user. More specifically, the user may be enabled by the input module 104 to move the selected terms of the sentence for modifying the sentence. The language module 106 may be configured to determine correctness of the modified sentence formed by the user.

In still another embodiment of the present disclosure, the language module 106 may be configured to insert a term of the plurality of terms in two directions, i.e., towards left of the parent term or towards right of the parent term. The language module 106 may be configured to insert a subsequent child term selected by the user prior to the parent term in the sentence. For example, the user may select a term ‘face’ for forming the sentence. Thereafter, the subsequent set of child terms that are capable of combining with the term ‘face’ may be retrieved from the repository 110 by the language module 106 and displayed to the user. The subsequent set of child terms may include ‘beautiful’, ‘handsome’ and ‘ugly’ as child terms that are capable of combining with parent term ‘face’. A child term, such as ‘beautiful’ may be selected by the user and may be inserted prior to the parent term ‘face’ by the language module 106.

Further, the language module 106 may be configured to retrieve the subsequent set of child terms from the repository 110 based on completeness of the sentence. More specifically, the language module 106 may be configured to retrieve a subsequent set of child terms from the repository 110 if the sentence is incomplete. In another embodiment, the language module 106 may be configured to retrieve the subsequent set of child terms from the repository 110 based on on completeness of the sentence. More specifically, the language module 106 may be configured to retrieve a subsequent set of child terms from the repository 110 if the sentence is incomplete. The language module is communicably coupled to the repository 110 for retrieving the plurality of terms and extracting the meaning corresponding to the indicated term.

The repository 110 of the system 100 includes the plurality of terms, a plurality of meanings and the grammatical rules of the target language. In an embodiment of the present disclosure, the plurality of terms may be stored in a plurality of files. In an embodiment of the present disclosure, the plurality of terms may be segregated into verbs, nouns and pronouns, and the like, and stored in the plurality of files.

Each file of the plurality of files may include at least one term of the plurality of terms and at least one grammatical rule of the grammatical rules. The at least one grammatical rule corresponds to the usage of the at least one term. Further, the each file may include special information of the at least one term. The special information may indicate the alternative sources for extracting the at least one grammatical rule. In another embodiment of the present disclosure, the each file may include exactly one term of the plurality of terms and a grammatical rule for usage of the term. The plurality of files may be created by a language expert of the target language. Alternatively, the plurality of files may be automatically generated out of a dictionary.

In still another embodiment of the present disclosure, the each file may include at least two terms and a set of grammatical rules or semantic conventions that define possible combinations of each term of the at least two terms. The set of grammatical rules or semantic conventions may be based on grammaticality or semantics of certain combinations in the target language. Further, the set of grammatical rules semantic conventions may be utilized by the language module 106 of the system 100 in order to provide feedback of a particular combination to the user.

In yet another embodiment of the present disclosure, the plurality of meanings is stored in a plurality of help files. Each help file of the plurality of help files includes a meaning of the plurality of meanings. The meaning corresponds to a term of the plurality of terms. Further, a help file of the plurality of help files may include information of the alternative source, such as a dictionary and an online website, for extracting the meaning of the corresponding term. In an embodiment of the present disclosure, a help file may correspond to a file of the plurality of files that stores exactly one term. In another embodiment of the present disclosure, a file corresponding to exactly one term may not be associated with the help file that includes the corresponding meaning. Accordingly, the language module 106 may be configured to search for the help file that includes the meaning of a term of the plurality of terms that is indicated by the user.

In an embodiment of the present disclosure, the plurality of files for storing the plurality of terms of the target language may be in Comma Separated Value (CSV) format. However, it will be apparent to a person skilled in the art that the plurality of files may be in any other format. Further, the plurality of terms may be stored in any other format, such as a database. Furthermore, the plurality of help files may be in an Extensible Markup Language (XML) format. However, it will be apparent to a person skilled in the art that the plurality of help files may be in any other suitable file format or any other database storage format.

In another embodiment of the present disclosure, the system 100 may be implemented as a game to be played by one or more players. Rules of the game may require the one or more players to construct fewest possible sentences for providing directions from a source location to a target location within a specific period of time, for example two minutes. The display module 102 of the system 100 may be communicably coupled to the timer module 108 for displaying time to a player constructing the sentences. The input module 104, such as a mouse, may be capable of enabling the user to move a mouse pointer back and forth among sets of terms that are displayed to the user. The user may be enabled to select an appropriate combination of terms to form the sentences for providing the directions. The game may include all embodiments as described previously.

In another embodiment of the present disclosure, the game may be based on a different set of rules. The display module 102 may display a picture and a sentence in the target language to the user. The sentence and the picture will be mismatched. A player of the game may be required to provide instructions to modify the picture for matching the picture with the sentence. The player may be allotted a predefined time for matching the sentence and the picture. In yet another embodiment of the present disclosure, the set of rules may require the player to construct sentences for ordering appropriate food items for satisfying a fictional character's hunger. In still another embodiment of the present disclosure, the set of rules may require the player to construct questions in the target language for solving a mystery. Upon construction of an appropriate question, the player may be provided a clue for solving the mystery. It will be apparent to a person skilled in the art that a variety of other games may exist. However, the game may be based on creating sentences in the target language.

In yet another embodiment of the present disclosure, the game may include a sentence and the set of modifiers may be displayed by the display module 102. An objective of the game may be to modify the sentence by using each modifier of the set of modifiers displayed.

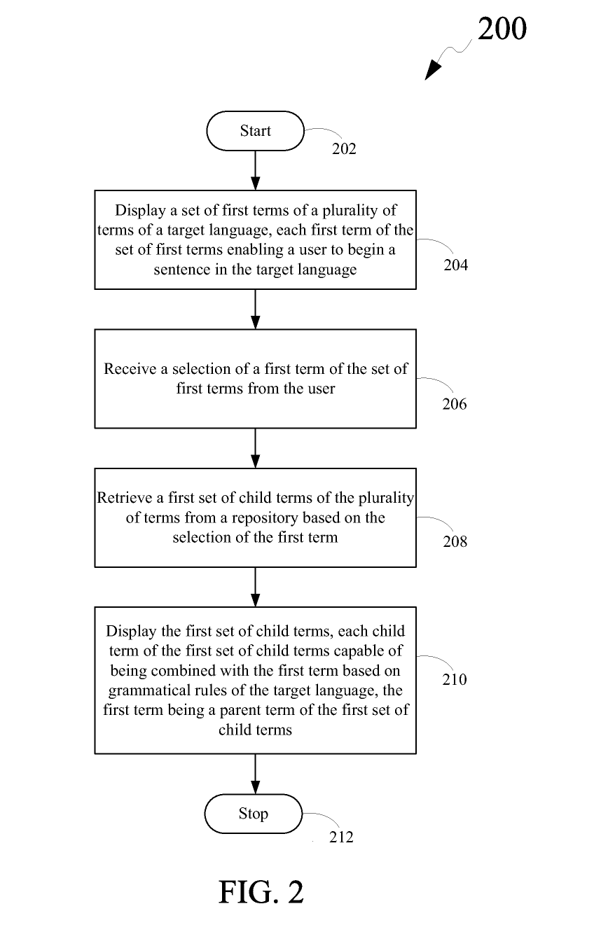

Further, it will be apparent to a person skilled in the art that the components described in FIG. 1, such as the display module 102, the input module 104, the language module 106, the timer module 108, the repository 110 and the transceiver module, may be implemented as hardware modules, software modules, firmware modules, or any combination thereof. Furthermore, it will be evident to those skilled in the art that the system 100 may include a microprocessor and a battery unit for performing typical functions of a computing system. A method for assisting the user in learning the target language is described in FIG. 2.

FIG. 2 is a flow diagram representing a method 200 for assisting a user in learning a target language, such as English, German, French, Latin, and the like, in accordance with an embodiment of the present disclosure. As explained previously, the target language includes a plurality of terms. The plurality of terms includes a plurality of words, such as ‘man’ and ‘adventure’ and a plurality of phrases, such as ‘pick-up’ and ‘carry on’. The method 200 may be performed by the user by using a processing device, such as a computer, a laptop, a mobile phone, a PDA, a gaming device, and the like.

At 202, method 200 begins. At 204, a set of first terms of a plurality of terms of the target language is displayed to the user. Each first term of the set of first terms enables the user to begin a sentence in the target language. At 206, a selection of a first term of the set of first terms is received from the user. At 208, a first set of child terms of the plurality of terms is retrieved from a repository based on the selection of the first term. At 210, the first set of child terms is displayed to the user. Each child term of the first set of child terms capable of being combined with the first term based on grammatical rules of the target language. The first term is a parent term of the first set of child terms. A term of the plurality of terms is associated with a meaning. The meaning may be represented visually. Further, a first child term of the first set of child terms is a parent term for a second set of child terms. The second set of child terms is displayed subsequent to the first set of child terms based on at least one of receiving a selection of the first child term and completion of the sentence in the target language. Furthermore, selections of the first term, the first child term and subsequent child terms are received from the user to form the sentence in the target language, thereby assisting the user to form the sentence in the target language. In yet another embodiment, based on the meaning of the sentence so completed or formed, the method may thereafter display a subsequent set of first terms, modify a previously-presented set of terms, display a question or dialog that is responsive to the formed sentence, and/or display a narrative element that corresponds to the formed sentence. At 212, the method 200 ends.

A sentence in the target language is formed by repeated selection of terms of the plurality of terms by the user. The sentence is begun by receiving the selection of the first term of the set of first terms displayed to the user. Examples of the first term of the set of first terms may include an article, such as ‘the’, ‘a’ and ‘an’, a noun such as ‘cat’, ‘girls’, and the like, and other similar terms, that may be used to begin the sentence in the target language. The set of first terms may be displayed to the user on a display module, such as the display module 102 of the system 100. The selection of the first term of the set of first terms may be received from the user through an input device, such as the input module 104 of the system 100, as explained in FIG. 1. Specifically, the selection of the first term may be received through one of keystrokes on a keyboard, movement of a joystick, pointing through a mouse, clicking on the mouse, touch on a touch screen device, a voice command provided to a microphone, and the like. The selection of the first term, such as ‘the’, may be received from the user.

Upon selection of the first term, the first set of child terms may be displayed to the user. The first set of child terms may be capable of being combined with a first term selected by the user, based on constraints chosen by a language expert who creates the repository. An example of the constraints chosen by the language expert may be the grammatical rules or semantic conventions of the target language. More specifically, the first term may be stored in the repository as a file. The file may include the first term and grammatical rules or semantic conventions corresponding to usage of the first term. The first set of child terms may be retrieved from the repository and displayed to the user, based on the grammatical rules or semantic conventions that correspond to the usage of the first term.

The first term may be referred to as the parent term of the first set of child terms. Examples of a child term of the first set of child terms that may be combined with the first term ‘the’, include ‘car’, ‘time’, and other similar terms. Thereafter, a selection of a first child term of the first set of child terms may be received from the user. For example, the user may select ‘car’ as the first child term.

The first child term is the parent term for a subsequent set of child terms, i.e., the second set of child terms. Each child term of the second set of child terms may be capable of being combined with the terms selected by the user, i.e. the first term and the first child term in combination, to form a meaningful sentence that conforms to the grammatical rules of the target language. Upon selection of the first child term, the second set of child terms are retrieved from the repository, such as the repository 110 explained in FIG. 1. Examples of a child term of the second set of child terms that can be combined with the first term ‘the’ and the first child term ‘car’ include ‘is’, ‘was’, ‘will be’, and the like. Thereafter, a selection of a second child term of the set of child terms may be received from the user. For example, a child term ‘will be’ may be selected by the user as the second child term. Thereafter, another subsequent set of child terms may be displayed to the user. Such displaying of the subsequent set of child terms and receiving of selections of terms from the user are repeated till the sentence is formed in the target language. For example, the user may form a sentence, ‘The car will be washed tomorrow’, in the target language

In an embodiment of the present disclosure, the user may be displayed a feedback upon selection of any term, such as the first term or any other intermediate child term. The feedback may include a picture that represents meaning of terms selected by the user for forming the sentence.

In another embodiment of the present disclosure, a set of terms of the plurality of terms, such as the first set of terms, the first set of child terms, the second set of child terms and the subsequent sets of child terms may be displayed as a set of buttons. Each button of the set of buttons may correspond to a term of the set of terms. Further, a selection of a button of the set of buttons may be received from the user to indicate the selection of a term of the set of terms. Specifically, the selection of the first term may be received when the selection of a button of the set of buttons is received from the user. The button corresponds to the first term. Similarly, the selection of a child term of the subsequent set of child terms may be received by receiving a selection of a button corresponding to the child term.

In still another embodiment of the present disclosure, a visibility of selected buttons may be maintained. The selected buttons correspond to terms selected by the user to form the sentence. For example, the selected buttons that correspond to terms of the sentence ‘The car will be washed tomorrow’ may be kept visible. Further, other terms of sets of terms that are displayed to the user may be made invisible. In an embodiment of the present disclosure, the selected buttons may be highlighted to show formation of the sentence.

In yet another embodiment of the present disclosure, each button of the set of buttons displayed to the user may have a shape. A shape of a button may be one of a geometrical shape, such as rectangle, square, triangle, pentagon, and the like, and a cartoon character shape, such as Mickey Mouse, Donald Duck, and the like. Alternatively, a button of the set of buttons may be shaped as a puzzle piece.

In still another embodiment of the present disclosure, an animation associated with the formation of the sentence may be displayed to the user. The animation represents connection of the selected terms to form the sentence. For example, for a sentence ‘The car is being washed’, an animation depicting formation of the sentence may be displayed. The animation may depict meanings of each of the selected terms.

In yet another embodiment of the present disclosure, a tense of the sentence may be displayed to the user to indicate one of a past tense, a present tense and a future tense of the sentence. The past tense, the present tense and the future tense may be indicated by at least one of a picture and a color. A white background color displayed for the sentence may indicate simple present tense. A grey background color and a clock with a backwards arrow may be displayed to indicate past tense. Further, the clock may be displayed with a forward arrow to indicate the future tense.

In still another embodiment of the present disclosure, a term of the plurality of terms may be inserted in two directions, i.e., towards left of the parent term or towards right of the parent term. A subsequent child term selected by the user may be inserted prior to the parent term in the sentence. For example, the user may select a term ‘face’ for forming the sentence. Thereafter, the subsequent set of child terms that are capable of combining with the term ‘face’ may be retrieved from the repository and displayed to the user. The subsequent set of child terms may include ‘beautiful’, ‘handsome’ and ‘ugly’ as child terms that are capable of combining with parent term ‘face’. A child term, such as ‘beautiful’ may be selected by the user and may be inserted prior to the parent term ‘face’.

In yet another embodiment of the present disclosure, a term of the set of terms may be associated with one of a color and a shape. The color or the shape may be associated with the term to indicate a gender-specific usage of the term. For example, in English, terms such as ‘her’, ‘his’, ‘herself’, and the like, are associated with a gender. In another example, in German all nouns are associated with a gender. In German, the sun, known as ‘Sonne’ is female and the moon known as ‘Mond’ is male. Accordingly, a color, such as pink may be associated with terms that are associated with female gender. Similarly, a color, such as blue, may be associated with terms that are associated with male gender. Alternatively, terms of the female gender may be associated with a first pre-defined shape. Similarly, terms of the male gender may be associated with a second pre-defined shape. The term may be displayed as a button that is colored with the associated color or shaped according to the gender of the term, thereby indicating the usage of the term to the user.

In yet another embodiment of the present disclosure, upon selection of a term of the subsequent set of terms by the user, a separable affix that is used in conjunction with the term may be displayed to the user. The affix may be depicted as floating, and may join with the sentence at an appropriate position upon selection of the term.

As explained in FIG. 1, the plurality of terms may be stored in the repository as a plurality of files. However, the plurality of terms may be stored in any other storage format.

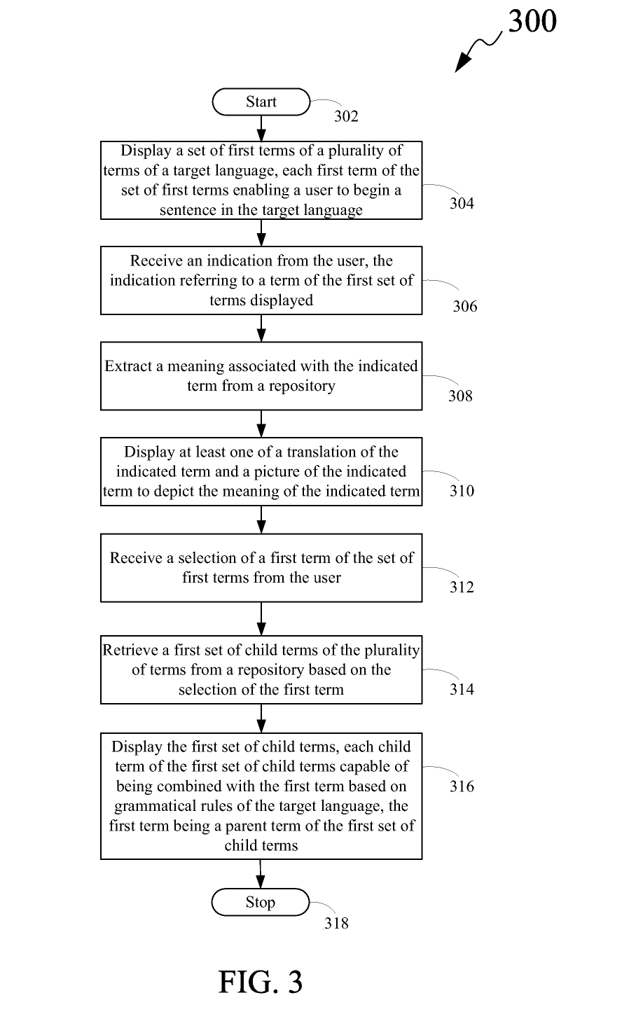

It will be evident to a person skilled in the art that multiple combinations of the various embodiments may exist in the method 200. Another method for assisting the user in learning the target language is explained in FIG. 3.

FIG. 3 is a flow diagram representing a method 300 for assisting a user in learning a target language, in accordance with an embodiment of the present disclosure. The target language includes a plurality of terms. The plurality of terms includes a plurality of words and a plurality of phrases. The method 300 illustrates displaying a meaning of a term of the plurality of terms to the user. The meaning may be represented as one of a translation of the term and a picture of the term.

The method 300 begins at 302. At 304, a set of first terms of the plurality of terms is displayed to the user. Each first term of the set of first terms enables the user to begin the sentence in the target language. For example, the set of first terms, such as ‘Flowers’, ‘Spices’, and the like, that are capable of beginning a sentence may be displayed to the user. At 306, an indication may be received from the user. The indication may refer to a term of the first set of terms that is displayed to the user. For example, the indication may refer to the term ‘flowers’ that is displayed to the user.

Specifically, the user may require the meaning of a term while forming the sentence in the target language. The user may indicate the term through an input module, such as the input module 104, explained in FIG. 1. In an embodiment of the present disclosure, a pointer pointing to the term may be received as the indication of the term. The pointer may be pointed to the term for a pre-defined period of time to be received as the indication. In an embodiment of the present disclosure, the pre-defined Period of time may be a randomly generated number. Duration of presence of the pointer on the term may be calculated. For example, the user may point a pointer of a mouse on the term for five seconds to indicate that the meaning of the term is required.

At 308, the meaning associated with the indicated may be extracted from a repository, such as the repository 110 explained in FIG. 1. Specifically, the meaning may be extracted from a help file of a plurality of help files in the repository. Alternatively, the meaning may be extracted from an alternative source, such as a website or a dictionary. The meaning of the term may be one of the translation of the term and the picture of the term.

At 310, at least one of the translation of the indicated term and the picture of the indicated term may be displayed to depict the meaning of the term. For example, for the term ‘flowers’ indicated by the user, a translation of the indicated term ‘flowers’ in a language known to the user may be displayed. Alternatively, a picture depicting flowers may be displayed to the user to indicate the meaning of the indicated term. In an embodiment of the present disclosure, both, the translation of the indicated term and the picture of the indicated term may be displayed to the user.

At 312, a selection of a first term of the set of first terms may be received from the user. At 314, a first set of child terms of the plurality of terms may be retrieved from the repository, based on the selection of the first term. The first set of child terms may be retrieved from the repository based on grammatical rules corresponding to usage of the first term. At 316, the first set of child terms may be displayed to the user. Each child term of the set of child terms is capable of being combined with the first term based on grammatical rules of the target language. The first term is a parent term of the first set of child terms. At 318, the method 300 stops.

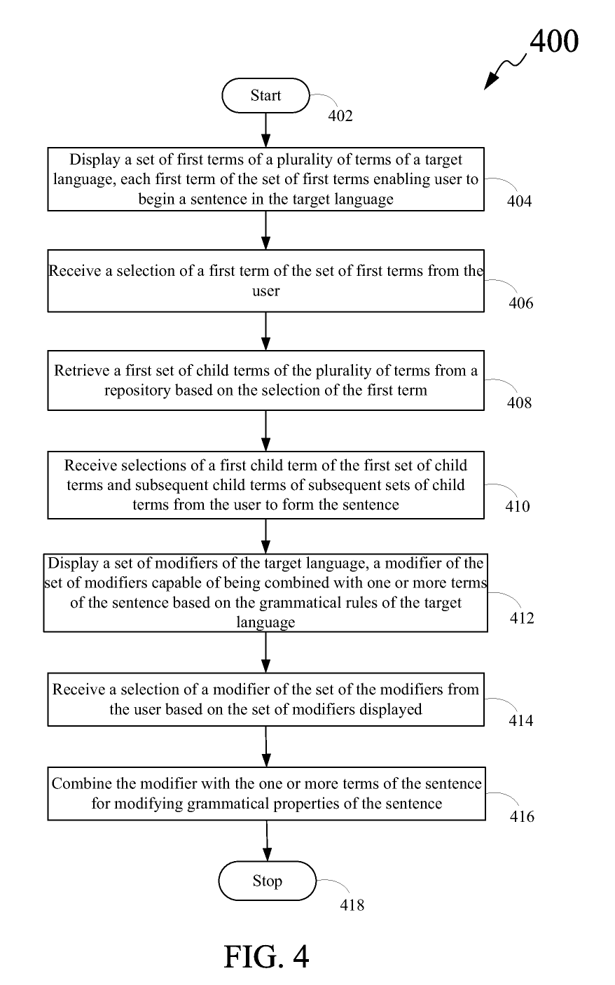

It will be apparent to a person skilled in the art that similar to displaying the meaning of the first term, the meaning corresponding to any term of a subsequent set of terms may be displayed to the user. Further, the user may be displayed meanings of multiple terms of the subsequent set of terms. Another method for assisting the user in learning the target language is explained in FIG. 4.

FIG. 4 is a flow diagram representing a method 400 for assisting a user in learning a target language, in accordance with another embodiment of the present disclosure. The target language includes a plurality of terms. The plurality of terms includes a plurality of words and a plurality of phrases. Specifically, the method 400 illustrates modifying grammatical properties of the sentence.

At 402, method 400 begins. At 404, a set of first terms of the plurality of terms of the target language is displayed to the user. Each first term of the set of first terms enables the user to begin a sentence in the target language. At 406, a selection of a first term of the set of first terms is received from the user. At 408, a first set of child terms of the plurality of terms is retrieved from a repository, such as the repository 110 explained in FIG. 1. The first set of child terms is retrieved based on the selection of the first term. Each child term of the first set of child terms is capable of being combined with the first term based on grammatical rules or semantic conventions of the target language.

At 410, selections of a first child term of the first set of child terms and subsequent child terms of subsequent sets of child terms are received from the user to form the sentence. For example, the user may form the sentence ‘The quick brown fox jumps over the lazy dog’. At 412, a set of modifiers of the target language may be displayed to the user. A modifier of the set of modifiers is capable of being combined with one or more terms of the sentence based on the grammatical rules of the target language. For example, a modifier, such as ‘would have’ may be displayed to the user. At 414, a selection of a modifier of the set of modifiers may be received from the user based on the set of modifiers displayed. The user may select the modifier ‘would have’, to convert the sentence into conditional perfect tense.

At 416, the modifier may be combined with the one or more terms of the sentence for modifying grammatical properties or semantic conventions of the sentence. Examples of a grammatical property of the sentence may include a tense of the sentence, grammatical number property of the sentence, a subject of the sentence, a direct object of the sentence, an indirect object of the sentence, an active voice or a passive voice of the sentence, and the like. The sentence may be modified to ‘The quick brown fox would have jumps over the lazy dog’. The modifier ‘would have’ may be combined with the one or more terms, ‘fox’ and ‘jumps’ to modify the sentence. Specifically, the modifier ‘would have’ is inserted between the one or more terms to modify the sentence. The modified sentence may not conform to the grammatical rules or semantic conventions of the target language. Accordingly, another modifier, such as a modifier ‘ed’ may be displayed to the user based on the modifier ‘would have’ selected by the user. The modifier ‘ed’ may be combined with the one or more terms of the sentence, such as ‘jumps’, to form ‘jumped’. The sentence may be modified to ‘The quick fox would have jumped over the lazy dog’ which is a conditional perfect tense of the sentence ‘The quick brown fox jumps over the lazy dog’. Accordingly, the tense of the sentence may be modified. In yet another embodiment, based on the meaning of the sentence so completed or formed, the method may thereafter display a subsequent set of first terms, modify a previously-presented set of terms, display a question or dialog that is responsive to the formed sentence, and/or display a narrative element that corresponds to the formed sentence. At 418, method 400 ends.

In an embodiment of the present disclosure, the set of modifiers may be displayed to the user as a menu option. The user may form the sentence in the target language. In another embodiment, the sentence may be formed from a repository (i.e., without the user's input), and then be displayed to the user along with the set of modifiers. Further, a menu option for modifying the grammatical properties of the sentence may be displayed to the user. A selection of the menu option for modifying the grammatical properties of the sentence may be received from the user through an input module, such as the input module 104 of the system 100.

In another embodiment of the present disclosure, upon selection of the menu option for modifying the grammatical properties, a sub-menu may be displayed to the user for selecting a specific grammatical property to modify the sentence. Accordingly, the set of modifiers displayed to the user may be capable of modifying specific grammatical properties of the sentence. For example, the set of modifiers displayed to the user may relate to modifying the tense of the sentence.

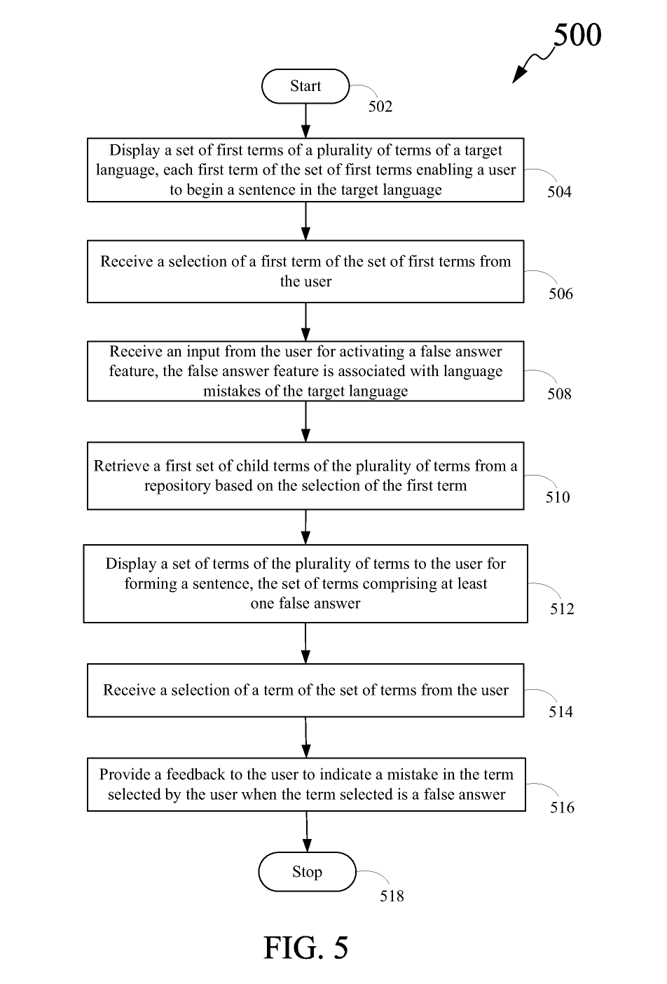

It will be apparent to a person skilled in the art that various combination of the embodiments described above may exist for the method 400. Another method for assisting the user in learning the target language is described in FIG. 5.

FIG. 5 is a flow diagram representing a method for assisting a user in learning a target language, in accordance with yet another embodiment of the present disclosure. The target language includes a plurality of terms. The plurality of terms includes a plurality of words and a plurality of phrases. More specifically, the method 500 illustrates a false answer feature for assisting the user in learning the target language.

At 502, method 500 begins. At 504, a set of first terms of the plurality of terms of the target language is displayed to the user. Each first term of the set of first terms enables the user to begin a sentence in the target language. At 506, a selection of a first term of the set of first terms is received from the user. At 508, an input is received from the user for activating a false answer feature. The false answer feature is associated with language mistakes of the target language. The input may be received through at least one of click on a mouse, movement of a joystick, a voice command, touch on a touch screen device, and the like.

At 510, a first set of child terms of the plurality of terms is retrieved from a repository, such as the repository 110, based on the selection of the first term. Further, the first set of child terms are retrieved based on the input received from the user for activating the false answer feature. Alternatively, the false answer feature may be activated based on settings configured by a user of a system, such as the system 100, on which the method 500 may be deployed. The first set of child terms retrieved from the repository may include at least one false answer. It will be apparent to a person skilled in the art that the at least one false answer may be present in any set of terms, such as the set of first terms and the subsequent child terms, that is retrieved for forming the sentence. Accordingly, for the purpose of explaining FIG. 5, the first set of child terms will hereinafter indicate any set of terms (referred to as ‘set of terms’) retrieved from the repository.

As explained previously, a false answer may be defined as a common language mistake that may be made by the user learning the target language. For example, for the target language, such as English, a term, such as ‘take’, may be modified from plural verb to singular verb to form ‘took’. However, such modification may not be applicable for each term of the plurality of terms of the target language. For example, a term, such as ‘make’, has a past tense form ‘made’. A false answer, such as ‘mook’ may be displayed to the user in the set of terms. A false answer of the at least one false answer may be randomly generated by a language module, such as the language module 106 of the system 100. Alternatively, the false answer may be pre-stored in the repository.

At 512, the set of terms retrieved from the repository may be displayed to the user. At 514, a selection of a term of the set of terms may be received from the user. At 516, a feedback may be provided to the user to indicate a mistake in the term selected by the user when the term selected is a false answer. For example, an animation depicting explosion of the false answer may be displayed to the user to indicate a mistake in selection of the term. Further, a pop-up may be displayed to the user. The pop-up may include an indicium to indicate correct form of the term selected by the user. For example, the pop-up may display the false answer ‘mook’ and the correct form ‘made’.

Thereafter, subsequent child terms may be received from the user to form the sentence in the target language. In yet another embodiment, based on the meaning of the sentence so completed or formed, the method may thereafter display a subsequent set of first terms, modify a previously-presented set of terms, display a question or dialog that is responsive to the formed sentence, and/or display a narrative element that corresponds to the formed sentence. At 518, method 500 ends. It will be apparent to a person skilled in the art that the false answer feature may be activated prior to displaying the first set of terms to the user. Accordingly, the at least one false answer may be included in any set of terms that is displayed to the user for forming the sentence. Further, the false answer feature may be displayed as a menu option to the user.

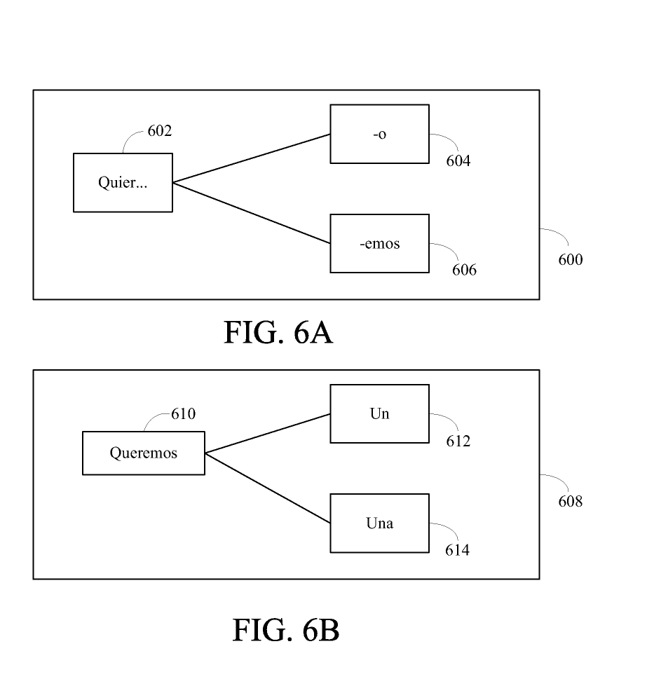

The embodiments described in FIGS. 2, 3, 4 and 5 may exist in combination to assist the user in learning the target language. As explained previously, the various embodiments may be displayed as menu options to the user. Further, methods 200, 300, 400 and 500 may assist the user in learning the target language. In an embodiment of the present disclosure, the methods 200-500 may be a part of a game that may exist on a device, such as a PDA, or within a video game. Each player in the game may be required to construct sentences in the target language in minimum time possible. The game may be based on rules for deciding a winner of the game. It will be apparent to a person skilled in the art that the methods 200-500 may be used for a variety of purposes. The embodiments explained above may be associated with specific user interfaces. User interfaces corresponding to the above embodiments are described in FIGS. 6, 7, 8, 9 and 10.

FIGS. 6A and 6B depict exemplary user interfaces for modifying grammatical properties of one or more terms in a target language, such as Spanish, in accordance with an exemplary embodiment of the present disclosure. FIG. 6A depicts a user interface 600 that includes a first set of modifiers, such as a first modifier 604 and a first modifier 606, that may be displayed to the user for modifying a term 602 of a sentence in the target language. FIG. 6B depicts a user interface 608 that includes a second set of modifiers, such as a second modifier 612 and a second modifier 614, for modifying a modified term 610 of the sentence. FIGS. 6A and 6B depict modifications to the one or more terms using inflections in Spanish.

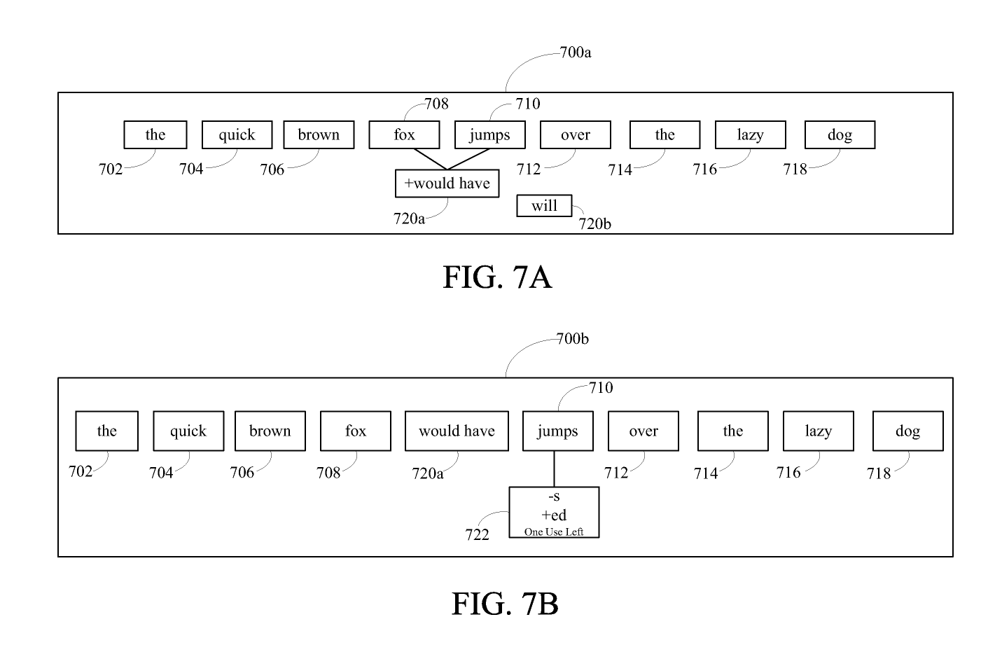

Referring to FIG. 6A, the term 602, i.e., ‘quier’ is a base term (hereinafter referred to as ‘base term 602’) in Spanish that does not have an independent existence. However, the base term 602 is capable of being combined with each modifier of the first set of modifiers. The user interface 600 may display the first set of modifiers to the user to enable the user to modify the base term 602. The first set of modifiers (depicted in FIG. 7) refers to a set of inflections in Spanish. A selection of the first modifier 606 may be received from the user by an input module, such as the input module 104. Thereafter, the base term 602 may be combined with the first modifier 606 to form the modified term 610 (shown in FIG. 6B). As depicted in FIGS. 6A and 6B, the combination causes a modification to the base term 602. The modification may be distinctly indicated to the user. Specifically, an animation may be displayed to the user to indicate that a letter ‘i’ may be removed from the base term 602 upon combining the base term 602 with the first modifier 606. The letter ‘i’ may turn red, blink and explode to emphasize on modifications made to the base term 602 upon combining with the first modifier 606.

Thereafter, the second set of modifiers may be displayed on the user interface 608. Each modifier of the second set of modifiers may be capable of being combined with the modified term 610 based on grammatical rules or semantic conventions of the target language. It will be apparent to a person skilled in the art that a modifier selected by the user may be combined with one or more terms of the sentence either to modify the grammatical properties or semantic conventions of the sentence or to build on base terms of the target language to form terms that have an independent form.

FIGS. 7A and 7B depict exemplary user interfaces for modifying grammatical properties of a sentence of a target language, in accordance with an embodiment of the present disclosure. More specifically, FIGS. 7A and 7B illustrate a user interface 700a and a user interface 700b, respectively, for modifying a grammatical property, such as a tense, of the sentence.

Referring to FIG. 7A, the user interface 700a includes the sentence in the target language. The sentence includes terms of the target language that are selected by a user (hereinafter referred to as ‘selected terms’). The selected terms include a term 702, a term 704, a term 706, a term 708, a term 710, a term 712, a term 714, a term 716, a term 718 and a term 720a and a term 720b. The terms 702-718 indicate the selected terms that form the sentence. A set of modifiers may be displayed on the user interface 700a for modifying the grammatical properties of the sentence. A term 720a and a term 720b depict a set of modifiers displayed on the user interface 700a to modify a tense of the sentence. In an embodiment of the present disclosure, a menu option may be provided to the user for indicating a grammatical property of the sentence that the user desires to modify. A menu option may be provided for each grammatical property supported by the target language.

The user may select a modifier of the set of modifiers for inserting into the sentence. For example, the term 720a may be selected by the user. The term 720a may be inserted between the term 708 and the term 710 based on grammatical rules or semantic conventions of the target language. In an embodiment of the present disclosure, the terms 708 and 710 may get highlighted upon selection of the term 720a to indicate to the user that the term 720a should be inserted between the terms 708 and 710.

Referring to FIG. 7B, the user interface 700b includes the sentence of FIG. 7A with the term 720a inserted between the terms 708 and 710. A term 722 may be displayed on the user interface 700b based on the insertion of the term 720a in the sentence. The term 722 may include text suggesting modifications to one or more terms of the sentence, such that the sentence conforms to the grammatical rules or semantic conventions of the target language. For example, the term 710, i.e. ‘jumps’ may need to be modified to ‘jumped’ based on the term 720a inserted in the sentence. Accordingly, upon selection of the term 722 the sentence may be modified from present simple tense to past participle form.

It will be apparent to a person skilled in the art that one or more grammatical properties, such as tense of the sentence, grammatical number property of the sentence, a subject of the sentence, a direct object of the sentence, an indirect object of the sentence, an active voice of the sentence or a passive voice of the sentence, and the like, may be modified by the user. Further, menu options may be provided for each grammatical property.

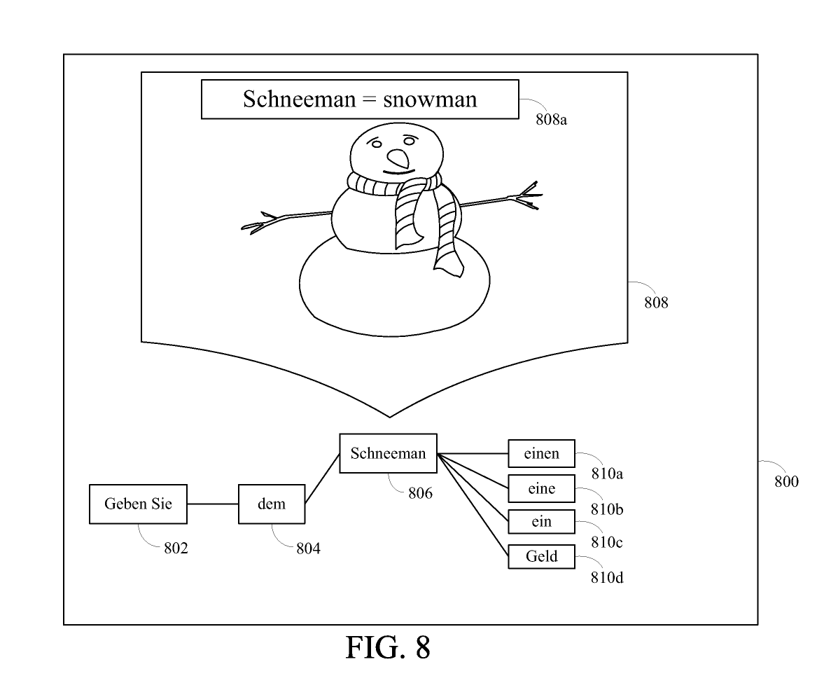

FIG. 8 depicts an exemplary user interface 800 for displaying a meaning of a term of a plurality of terms of a target language, such as German, to the user, in accordance with an exemplary embodiment of the present disclosure. The user interface 800 includes a button 802, a button 804, a button 806, a pop-up 808 and a set of buttons, such as a button 810a, a button 810b, a button 810c and a button 810d.

As explained previously, the user may form a sentence by selecting terms of a plurality of terms of the language. Each term that is displayed to the user may be a button, as depicted in FIG. 8. While forming the sentence in the target language, the meaning of a term may be displayed to the user based upon an indication received from the user. For example, a term corresponding to the button 806 (hereinafter referred to as ‘term 806’) may be displayed to the user on the user interface 800. The user may require the meaning of the term 806. The user may point to the term 806 using an input module, such as a mouse, a stylus, and the like, for a pre-defined period of time. The pre-defined period of time may be 5 seconds. In an embodiment of the present disclosure, the pre-defined period of time may be a randomly generated number. Upon pointing the input device on the term 806 for 5 seconds, the meaning of the term 806 may be displayed in the pop-up 808. The meaning of the term 806 may include at least one of a picture of the term 806 and a translation of the term 806. The picture of the term 806 is as depicted in FIG. 8, and the translation of the term 806 is displayed in a translation box 808a. It will be apparent to a person skilled in the art that the translation may be provided to the user in a language that is known to the user.

The user may provide the selection of the term 806 through the user interface 800. The term 806 selected by the user may be a parent term for a subsequent set of child terms. Each child term of the subsequent set of child terms may correspond to a button of the set of buttons. The user may point to a button, such as the button 810b, of the set of buttons to extract the meaning of a term corresponding to the button.

The user interface 800 also depicts that visibility of selected buttons that form the sentence, is maintained. The button 802 and the button 804 correspond to terms that have been selected by the user for forming the sentence. Upon selection of a term of a set of terms displayed to the user, remaining terms of the set of terms are made invisible. For example, upon selection of the button 810b that corresponds to a term ‘eine’, remaining buttons of the set of buttons may be made invisible in the user interface 800.

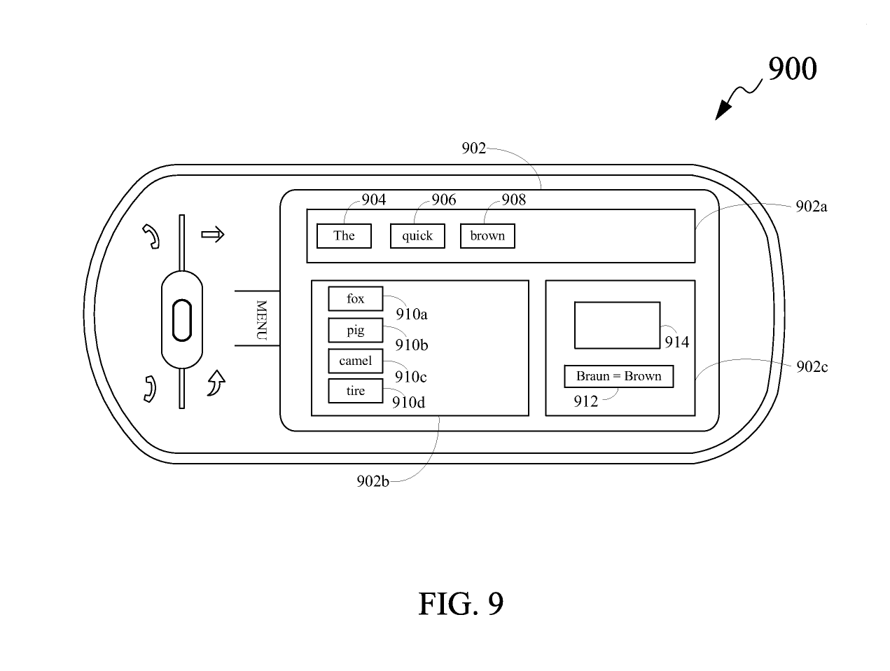

FIG. 9 depicts a user interface 902 on a processing device 900 for assisting a user in forming a sentence in a target language, in accordance with an embodiment of the present disclosure. Examples of the processing device 900 include a PDA, a mobile phone, a palmtop, and the like. The user interface 902 is a screen of the processing device 900.

The user interface 902 includes a first interface 902a, a second interface 902b and a third interface 902c. The first interface 902a depicts terms that are selected by the user for forming the sentence. The second interface 902b depicts a subsequent set of child terms that are displayed to the user. The subsequent set of child terms are capable of being combined with a parent term of the sentence based on grammatical rules of the target language. The third interface 902c depicts a meaning of a term indicated by the user. The meaning may be associated with a term selected by the user for combining with the sentence. Alternatively, the meaning may be associated with a child term of the subsequent set of child terms displayed in the second interface 902b.

The first interface 902a includes a term 904, a term 906 and a term 908 that are selected by the user for forming the sentence. The user may point to the term 908 to indicate that the meaning of the term 908 is required. In an embodiment of the present disclosure, the user may indicate the term 908 by touching the user interface 902 when the user interface 902 is a touch screen device. In another embodiment of the present disclosure, the processing device 900, such as a mobile phone, may include buttons for enabling the user to indicate the term 908. Upon indicating the term 908, the meaning of the term 908 is displayed in the third interface 902c.

The third interface 902c includes a translation box 912 and a picture box 914. The translation box 912 displays a translation of the term 908 and the picture box 914 displays a picture of the term 908. In this case, the picture box 914 may be shaded brown to indicate the term 908, i.e. ‘brown’.

The second interface 902b includes the subsequent set of child terms for the parent term, i.e. the term 908 selected by the user. Specifically, the second interface 902b includes a term 910a, a term 9102b, a term 910c and a term 910d as child terms of the term 908.

It will be apparent to a person skilled in the art that the processing device 900 may be configured to display other embodiments as explained above, in the methods 200-500.

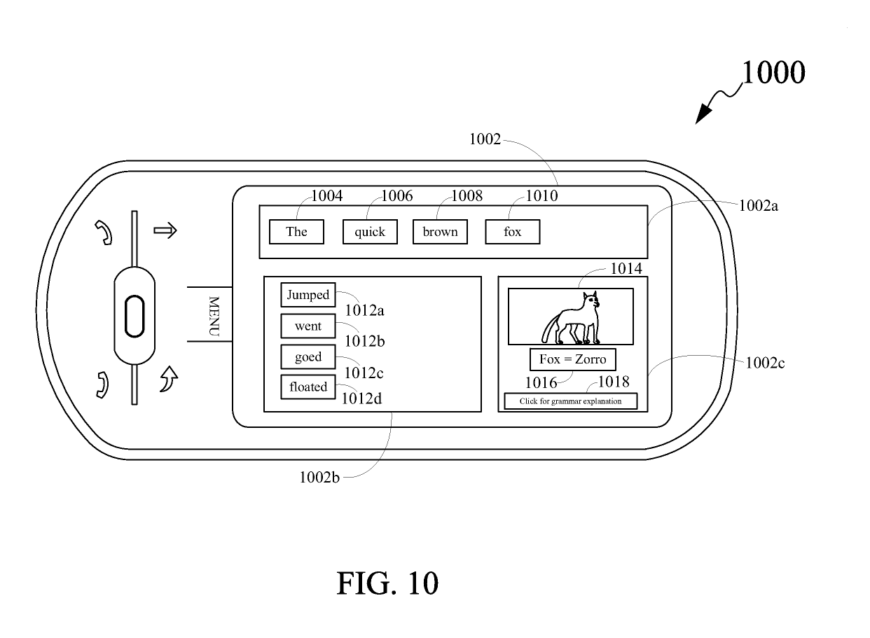

FIG. 10 depicts a user interface 1002 on a processing device 1000 with a false answer feature activated, in accordance with an embodiment of the present disclosure. As explained previously in conjunction with FIG. 5, the false answer feature is associated with language mistakes of the target language.

The user interface 1002 includes a first interface 1002a, a second interface 1002b and a third interface 1002c. The first interface 1002a depicts terms that are selected by the user for forming the sentence. The second interface 1002b depicts a subsequent set of child terms that are displayed to the user. The third interface 1002c depicts a meaning of a term indicated by the user.

The first interface 1002a includes a term 1004, a term 1006, a term 1008 and a term 1010. The terms 1004, 1006, 1008 and 1010 are selected by the user for forming the sentence. The term 1010 selected by the user is a parent term for the subsequent set of child terms displayed in the second interface 1002b. The second interface 1002b includes a term 1012a, a term 1012b, a term 1012c and a term 1012d (collectively referred to as ‘subsequent set of child terms’). The subsequent set of child terms may include at least one false answer, such as the term 1012c. As explained previously, a false answer may be defined as a common language mistake that may be made by the user learning the target language.

The at least one false answer is displayed on the second interface 1002b when the false answer feature is activated on the processing device 1000. Further, upon selection of a false answer, such as the term 1012c, by the user, an animation depicting explosion of the false answer may be displayed to the user. The animation may indicate a mistake in the selection of the term 1012c. Further, an indicium may be displayed to the user in the third interface 1002c, to indicate a correct form of the term selected by the user. For example, the indicium may indicate that the term 1012b, i.e. ‘went’ is the correct form of the term 1012c, i.e. ‘goed’.

The third interface 1002c depicts the meaning of the term 1010 indicated by the user. The third interface 1002c includes a picture box 1014, a translation box 1016 and a help box 1018. The picture box 1014 displays a picture of the term 1010. The translation box 1016 displays a translation of the term 1010 in a language that is understood by the user. Further, the help box 1018 may assist the user in understanding usage of the term 1010. The user may be enabled to select the help box 1018. Upon selection of the help box 1018, information regarding usage of the term 1010 may be displayed to the user.

The false answer feature may be activated by the user on the processing device 1000. The false answer feature may be activated upon receiving an input from the user. Alternatively, the false answer feature may be activated based on settings that may be configured by the user of the processing device 1000. Further, the false answer feature may be configured by a language expert, who may set-up grammatical rules of the target language in the repository. The false answer feature may be provided as a menu option to the user.

It will be apparent to a person skilled in the art that other menu options as described in the methods 200-500 above may also be provided on the processing device 1000.

Assisting a user in learning a target language as implemented by a system, such as the system 100 of the present disclosure, is beneficial as the system enables the user to apply a cognitive thinking process while learning the target language. The system enables the user to construct sentences in the target language. Further the system assists the user in understanding the vocabulary of the target language by visually depicting meanings of terms of the target language. The system includes a false answer feature that provides a visual feedback to the user when a mistake is made by the user. Still further, the system is capable of displaying animation depicting formation of a sentence in the target language to the user. Due to the inherent capability of human beings to better grasp visual feedback, process of learning the target language is expedited.

Further, implementation of the system on a processing device, such as Personal Digital Assistant, mobile phone, gaming device, and the like, enable the user to conveniently access the system. Furthermore, the system may be implemented as a menu system to provide different options to the user in a menu based format. Still further, the system is capable of updating the target language by using alternative sources, such as dictionaries, websites, and the like. Yet further, the system ensures privacy and conforms to child protection laws when the system is implemented as a game played over a communication medium, such as the Internet. The game may be capable of restricting terms displayed to the user, such as a child, thereby ensuring that private information of the child cannot be revealed while playing the game. Still further, an input module of the system enables the user to construct sentences in the target language in a fast, simple and reliable manner, making it practical for use within gaming and other environments.

As described above, the embodiments of the present disclosure may be embodied in the form of a computer program product for assisting a user in learning a target language. Embodiments of the present disclosure may also be embodied in the form of program module containing a set of instructions embodied in tangible media, such as floppy diskettes, CD-ROMs, hard drives, or any other computer-readable storage medium, wherein, when the program module is loaded into and executed by a computer, the computer becomes an apparatus for practicing the present disclosure. It will be apparent to a person skilled in the art that the present disclosure as described above, may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the present disclosure. When implemented on a general-purpose microprocessor, the computer program code segments configure the microprocessor to create specific logic circuits.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

What is claimed is:

1. A method for assisting a user in learning a target language, the target language comprising a plurality of terms, the plurality of terms comprising a plurality of words and a plurality of phrases, the method comprising:
displaying a set of first terms of the plurality of terms, each first term of the set of first terms enabling the user to begin a sentence in the target language;
receiving a selection of a first term of the set of first terms from the user;
retrieving a first set of child terms of the plurality of terms from a repository based on the selection of the first term; and
displaying the first set of child terms, each child term of the first set of child terms capable of being combined with the first term based on at least one of grammatical rules and semantic conventions of the target language, the first term being a parent term of the first set of child terms;
wherein a term of the plurality of terms is associated with a meaning, the meaning being represented visually, and
wherein a first child term of the first set of child terms is a parent term for a second set of child terms, the second set of child terms displayed subsequent to the first set of child terms based on at least one the first set of child terms, receiving a selection of the first child term and completion of the sentence in the target language, and
wherein selections of the first term, the first child term and subsequent child terms are received from the user to form the sentence in the target language, thereby assisting the user in learning the target language, and
wherein the meaning of the sentence so formed determines at least one of (a) a subsequent display of first terms, (b) modification of a previously presented display of terms, (c) subsequent display of a question or dialog that is responsive to the formed sentence, and (d) subsequent display of a narrative element.

2. The method of claim 1, wherein displaying a set of terms of the plurality of terms comprises displaying a set of buttons, each button of the set of buttons corresponding to a term of the set of terms, the set of terms being one of the set of first terms and a subsequent set of child terms of the plurality of terms,
wherein receiving the selection of a term comprises receiving a selection of a button of the set of buttons from the user, the button corresponding to the selected term.

3. The method of claim 2, further comprising maintaining visibility of selected buttons, the selected buttons corresponding to terms selected by the user to form the sentence, and the visibility of the selected buttons allowing the buttons that have previously received a selection to receive another selection.

4. The method of claim 1, wherein the repository comprises the plurality of terms, a plurality of meanings, the grammatical rules, and semantic conventions of the target language.

5. The method of claim 1 further comprising displaying a set of modifiers of the target language, a modifier of the set of modifiers capable of being combined with one or more terms of the sentence based on at least one of the grammatical rules and the semantic conventions of the target language.

6. The method of claim 1 further comprising receiving an input from the user for activating a false answer feature, the false answer feature associated with common language mistakes of the target language, wherein the false answer feature comprises displaying a set of terms of the plurality of terms to the user for forming the sentence, the set of terms comprising at least one false answer, receiving a selection of a term of the set of terms from the user, and providing a feedback to the user to indicate a mistake in the term selected by the user when the term selected is a false answer.

7. A system for assisting a user in learning a target language, the target language comprising a plurality of terms, the plurality of terms comprising a plurality of words and a plurality of phrases, the system comprising:
a display module capable of displaying a set of first terms of the plurality of terms, each first term of the set of first terms enabling the user to begin a sentence in the target language;
an input module capable of receiving a selection of a first term of the set of first terms from the user; and
a language module capable of retrieving a first set of child terms of the plurality of terms from a repository based on the selection of the first term,
wherein the display module is further capable of displaying the first set of child terms, each child term of the first set of child terms capable of being combined with the first term based on at least one of grammatical rules and semantic conventions of the target language, the first term being a parent term of the first set of child terms, and
wherein a term of the plurality of terms is associated with a meaning, the meaning being represented visually, and
wherein a first child term of the first set of child terms is a parent term for a second set of child terms, the second set of child terms displayed by the display module subsequent to the first set of child terms based on at least one of the first set of child terms, receiving a selection of the first child term by the input module and completion of the sentence in the target language, and
wherein selections of the first term, the first child term and subsequent child terms are received from the user by using the input module to form the sentence in the target language, thereby assisting the user in learning the target language, and
wherein the meaning of the sentence so formed determines at least one of (a) a subsequent display of first terms, (b) modification of a previously presented display of terms, (c) subsequent display of a question or dialog that is responsive to the formed sentence, and (d) subsequent display of a narrative element.

8. The system of claim 7, wherein displaying a set of terms of the plurality of terms comprises displaying a set of buttons, each button of the set of buttons corresponding to a term of the set of terms, the set of terms being one of the set of first terms and a subsequent set of child terms of the plurality of terms,
wherein receiving the selection of a term comprises receiving a selection of a button of the set of buttons from the user, the button corresponding to the selected term.

9. The system of claim 7, wherein the input module is further capable of receiving a selection of a button of the set of buttons from the user.

10. The system of claim 7, wherein the display module is configured to maintain visibility of selected buttons, the selected buttons corresponding to terms selected by the user to form the sentence, and the visibility of the selected buttons allowing the buttons that have previously received a selection to receive another selection.

11. The system of claim 7, wherein the display module is configured to display a set of modifiers of the target language, a modifier of the set of modifiers capable of being combined with one or more terms of the sentence based on at least one of the grammatical rules and semantic conventions of the target language.

12. The system of claim 7, wherein the language module is configured to enable the user to modify at least one of grammatical properties and semantic conventions of the sentence based on the set of modifiers displayed by the display module, the grammatical properties of the sentence being one of a tense of the sentence, a grammatical number property of the sentence, a subject of the sentence, a direct object of the sentence, an indirect object of the sentence and an active-passive voice of the sentence.

13. The system of claim 7 wherein the input module is configured to receive an input from the user for activating a false answer feature, the false answer feature associated with common language mistakes of the target language.

14. A computer program product embodied on a computer readable medium, for assisting a user in learning a target language, the target language comprising a plurality of terms, the plurality of terms comprising a plurality of words and a plurality of phrases, the computer program product comprising a program module, the program module comprising:
a set of instructions for displaying a set of first terms of the plurality of terms, each first term of the set of first terms enabling the user to begin a sentence in the target language;
a set of instructions for receiving a selection of a first term of the set of first terms from the user;
a set of instructions for retrieving a first set of child terms of the plurality of terms from a repository based on the selection of the first term; and
a set of instructions for displaying the first set of child terms, each child term of the first set of child terms capable of being combined with the first term based on at least one of grammatical rules and semantic conventions of the target language, the first term being a parent term of the first set of child terms;
wherein a term of the plurality of terms is associated with a meaning, the meaning being represented visually, and
wherein a first child term of the first set of child terms is a parent term for a second set of child terms, the second set of child terms displayed subsequent to the first set of child terms based on at least one of receiving a selection of the first child term and completion of the sentence in the target language, and
wherein selections of the first term, the first child term and subsequent child terms are received from the user to form the sentence in the target language, thereby assisting the user in learning the target language, and
wherein the meaning of the sentence so formed determines at least one of (a) a subsequent display of first terms, (b) modification of a previously presented display of terms, (c) subsequent display of a question or dialog that is responsive to the formed sentence, and (d) subsequent display of a narrative element.

15. The computer program product of claim 14, wherein the computer program product further comprises displaying a set of terms of the plurality of terms comprises displaying a set of buttons, each button of the set of buttons corresponding to a term of the set of terms, the set of terms being one of the set of first terms and a subsequent set of child terms of the plurality of terms,
wherein receiving the selection of a term comprises receiving a selection of a button of the set of buttons from the user, the button corresponding to the selected term.
